(19) United States
(12) Patent Application Publication
(10) Pub. No.: US 2007/0285844 A1
(43) Pub. Date: Dec. 13, 2007

(54) Multi-function head flex-circuit design for tape drives

(75) Inventors: Ashok Nayak, Glendora, CA (US); Jim Hammond, Santa Maria, CA (US)

Correspondence Address: LAW OFFICE OF MARK J. SPOLYAR, 2200 CESAR CHAVEZ STREET, SUITE 8, SAN FRANCISCO, CA, 94124, US

(73) Assignee: Quantum Corporation, a Delaware Corporation

(21) Appl. No.: 11/516,069

(22) Filed: Sep. 6, 2006

Related U.S. Application Data
(60) Provisional application No. 60/804,225, filed on Jun. 8, 2006.

(51) Int. Cl. G11B 5/54

(52) U.S. Cl. 360/250

(57) ABSTRACT

An exemplary embodiment provides for a servo-actuated, head actuator design wherein a head carriage includes one or more positional sensor location features that precisely define placement. The sensor location features are configured such that a positional sensor can be mated into a specific sensor location feature. As the head carriage is typically manufactured with great accuracy, the inclusion and placement of the sensor location features will also be extremely accurate. As a result, the location of positional sensors can be pre-defined via the head carriage design such that they will be at a precise location with respect to a magnetic head attached to the head carriage, thereby reducing variation in the location of one or more positional sensors resulting from a tape drive assembly process.

### CROSS-REFERENCE TO RELATED APPLICATIONS

This application claims the benefit of U.S. Provisional Patent Application No. 60/804,225 filed on Jun. 8, 2006, which is incorporated herein by reference.

### BACKGROUND

Modern tape drives involve multiple, tightly spaced tracks and use closed-loop servo systems to keep read/write elements, on a magnetic head, in alignment with the tracks. As part of that closed-loop servo system, tape drives utilize a variety of positional sensors to correctly the read/write elements at a selected track. Given the tight spacing of tracks, accuracy of the positional sensors is critical.

One component of a positional sensor's accuracy is the positional sensor's physical location as it is typically used in conjunction with a corresponding reference magnet. As a result, misplacement of the positional sensor can lead to inaccurate positioning of a read/write element in relation to a track on a tape. The positional sensors are typically installed on an actuator assembly that includes the magnetic head and, in a manufacturing environment, it is not uncommon to have an actuator rejection rate of several percentage points due to misplacement of the positional sensors. Due to these circumstances, methods and systems for accurately installing positional sensors on an actuator receive considerable attention.

One prior art technique for accurately installing positional sensors utilizes a sensor-locating jig. Generally speaking, a jig is a device used to maintain mechanically the correct positional relationship between a piece of work and the tool or between parts of work during assembly. Using the sensor-locating jig adds another step to what is typically a very complicated production process, however. Additionally, assembly variations of the other tape drive parts can contribute to misplacement of the positional sensors. Restated, the sensor-locating jig may accurately place a positional sensor on a particular part but that part may have not been properly positioned. As a result, use of a sensor locating jig to install positional sensors is not completely optimal.

Another aspect of modern tape drives is that printed circuit board (“PCB”) is typically limited due to the tape drive's small form factor. Also, connections to the PCB from various tape drive parts typically take up a considerable amount of PCB real estate. As a result, methods and systems which address these two related issues are desirable.

Yet another factor that complicates tape drive manufacturing is the soldering of various parts to an actuator assembly of a tape drive. In certain actuator assembly designs, a magnetic head needs to be installed before installation of other parts that require soldering. Due to this required assembly order, there is a potential that the magnetic head may be inadvertently damaged by the soldering gun. As the magnetic head is typically the most expensive single part of a tape drive, it would desirable to eliminate soldering from the manufacturing process in order to prevent the accidental head damage. Additionally, soldering produces dangerous fumes which necessitate proper ventilation systems which further add to the cost of the manufacturing process.

Additionally, several original equipment manufacturers require certified soldering which involves certification of factory workers in the art of soldering. The certification process also typically requires occasional re-certification. As a result, certified soldering increases tape drive manufacturing costs due to the extra expense required to maintain certification of factory personnel.

Yet another manufacturing issue involves soldering connections to head flex cables. Typically, head flex cables are used to connect a magnetic head to the PCB. However, some actuator assembly designs require additional connections, from other parts besides the magnetic head, to be soldered to the head flex cables. The soldered connections can be problematic during later testing of the magnetic head. If the magnetic head does not pass the testing, those soldered connections need to be undone so the magnetic head, along with the head flex cables, can be removed for repair or possible replacement. After the magnetic head is repaired or a new magnetic head is procured, the connections will then need to be re-soldered. As such, soldering can introduce numerous issues to the manufacturing process even.

In view of the foregoing, a need exists in the art for tape drives that address the various aforementioned issues.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, apparatuses and methods which are meant to be exemplary and illustrative, not limiting in scope. In various embodiments, one or more of the above-described problems have been reduced or eliminated.

One embodiment by way of non-limiting example provides for a servo-actuated, head actuator design wherein a head carriage includes one or more positional sensor location features that precisely define placement. The sensor location features are configured such that a positional sensor can be mated into a specific sensor location feature. As the head carriage is typically manufactured with great accuracy, the inclusion and placement of the sensor location features will also be extremely accurate. As a result, the location of positional sensors can be pre-defined via the head carriage design such that they will be at a precise location with respect to a magnetic head attached to the head carriage, thereby reducing variation in the location of one or more positional sensors resulting from a tape drive assembly process.

Other embodiments by way of non-limiting example provide for facilitating electrical interconnects between the PCB of a tape drive and one or more actuator components without the use of soldering for certain parts. In one implementation, the interconnects for the magnetic head, voice coil and a positional sensor are incorporated into a single flex circuit and corresponding connector on the PCB. In addition, the voice coil flex circuit, in one implementation, is designed to have its positive line and its negative line terminate to two pads. The two-voice coil lines from the head flex circuit also terminate to similar size pads. During assembly of the actuator, the pads of the voice coil are mated to the pads of the head flex circuit and are clamped together by a flexure clamp in one implementation or, in another implementation, clamped between a head carriage and a voice coil holder wherein the clamping force is achieve by screws holding the head carriage and voice coil motor firmly together. These implementations eliminate the need for soldering of these connections. As a result, assembly and disassembly of the assembly to and from the actuator assembly is facilitated. In addition, when the relevant fasteners are removed to disengage the head carriage from the actuator assembly, separate disassembly is not required for the hall sensors or the voice coil. Furthermore, cost reductions are realized by the elimination of multiple conductors for various interconnects between the various devices and the main PCB of the tape drive. Additionally, elimination of several connectors allows for reductions in PCB size or utilization of PCB space for other purposes.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 illustrates a typical LTO tape cartridge;

FIG. 2 illustrates a typical LTO tape drive housing with the cartridge of FIG. 1 inserted;

FIG. 3 is a top-down view of the cartridge inserted into the tape drive and further illustrates various internal tape drive parts;

FIG. 4 is a perspective view of an actuator assembly, in accordance with an exemplary embodiment;

FIG. 5A is a perspective view of a fine actuator, in accordance with an exemplary embodiment;

FIG. 5B is cut-through perspective view of the fine actuator of FIG. 5A;

FIG. 6 is a perspective view of a backside of a head carriage which illustrates an embodiment for precisely locating positional sensors, in accordance with an exemplary embodiment;

FIG. 7A is a perspective view of a voice coil, a voice coil holder and the head carriage which illustrates an embodiment for clamping a voice coil flex circuit to a first head flex circuit, in accordance with an exemplary embodiment; and

FIG. 7B. is a perspective view of the voice coil holder and the voice coil 414, in accordance with an exemplary embodiment;

FIGS. 8-12 are various perspective views illustrating an alternative embodiment for clamping the voice coil flex circuit to the first head flex circuit, in accordance with an exemplary embodiment.

### DETAILED DESCRIPTION

The following embodiments and aspects thereof are described and illustrated in conjunction with systems, apparatuses and methods which are meant to be exemplary and illustrative, not limiting in scope.

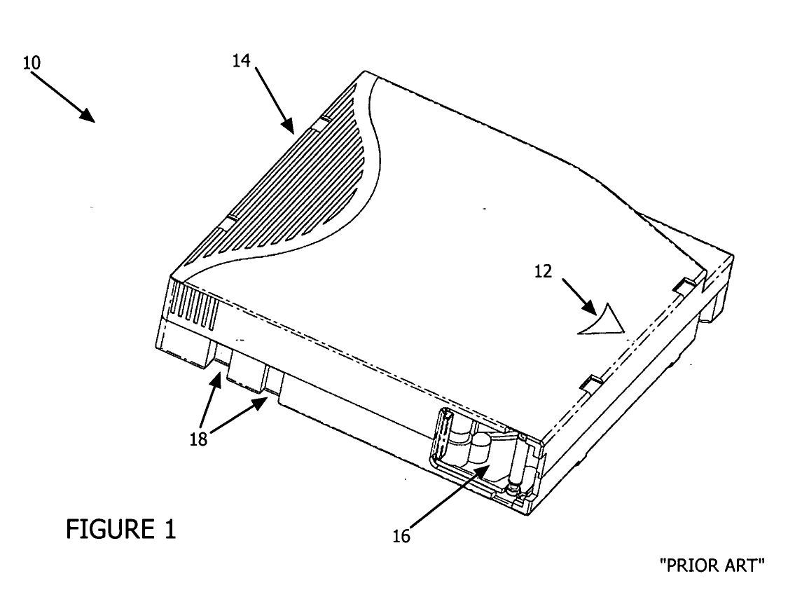

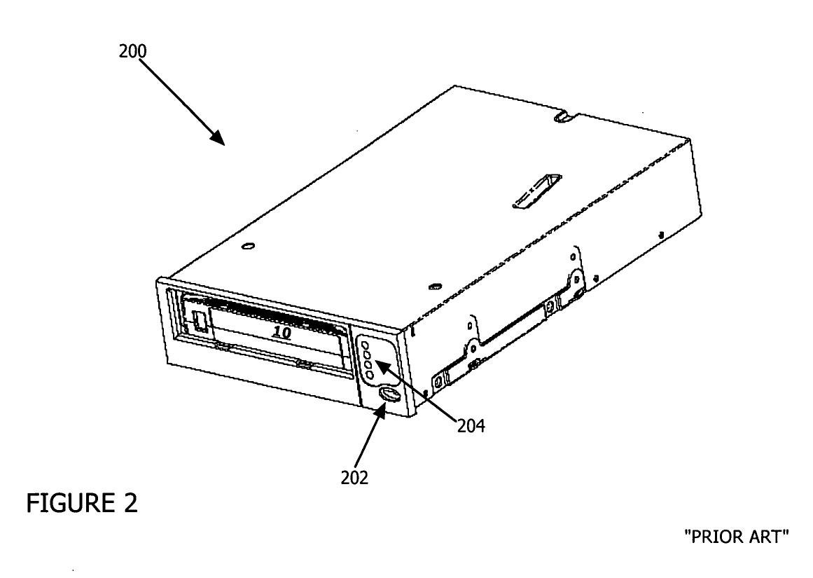

FIG. 1 illustrates a typical LTO tape cartridge 10 and FIG. 2 illustrates a typical LTO tape drive housing 200 with the cartridge 10 of FIG. 1 inserted. Cartridge 10 is inserted into drive 200 in a direction specified by arrow 12. Cartridge 10 also includes grip lines 14 for easy handling. Additionally, cartridge 10 includes various lock depressions 18 (also repeated on the opposite side) that mate with a male counterpart, in drive 200, to ensure a snug fit after cartridge 10 is inserted into drive 200. Drive 200 includes an eject button 202 and various indicators 204. The drive 200 may be designed to fit into a half-high 5.25 inch form factor for installation into a bay of a desktop or server box. Of course, other implementations are possible. For example, the drive 200 may be a stand-alone unit, such as a desktop drive that is external from a host computing system.

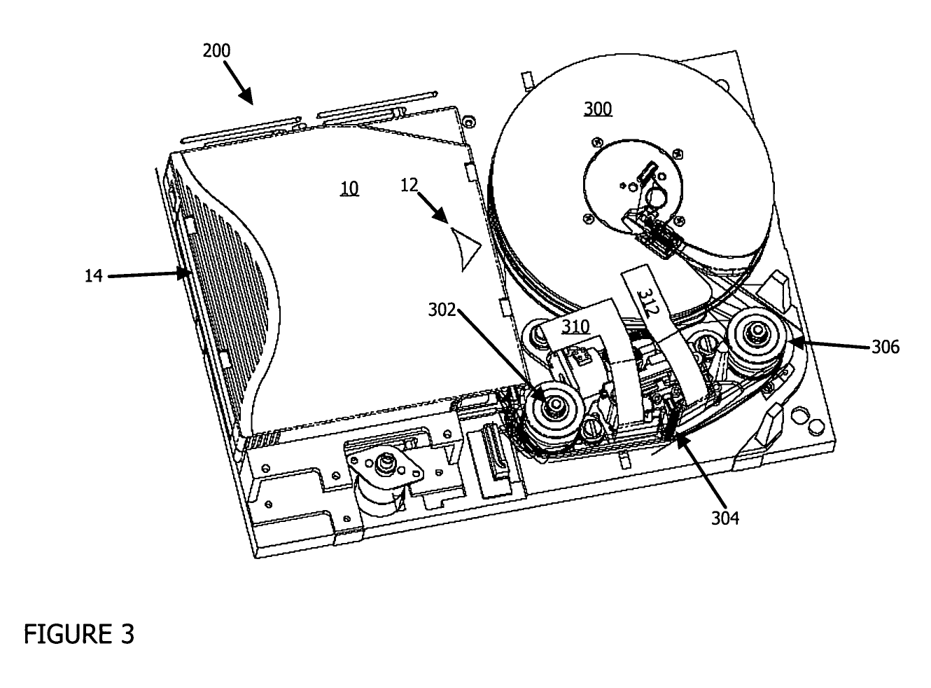

FIG. 3 is a top-down view of the cartridge 10 inserted into the tape drive 200 which includes a head actuator assembly that incorporates aspects of the claimed embodiments. A full description of the various components of drive 200 is intentionally not included in order to not unnecessarily obscure the claimed embodiments. However, some of the major components include a take-up hub 300, various tape-threading roller guides (302, 306), magnetic head 304 and head flex circuits (310, 312). Drive 200 will also typically contain one or more processors, a memory and a controller.

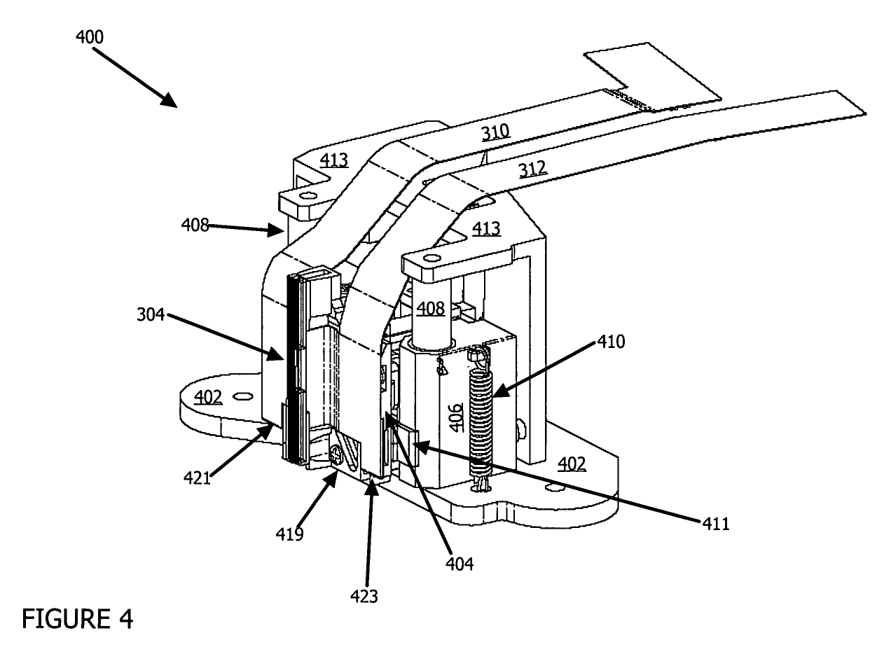

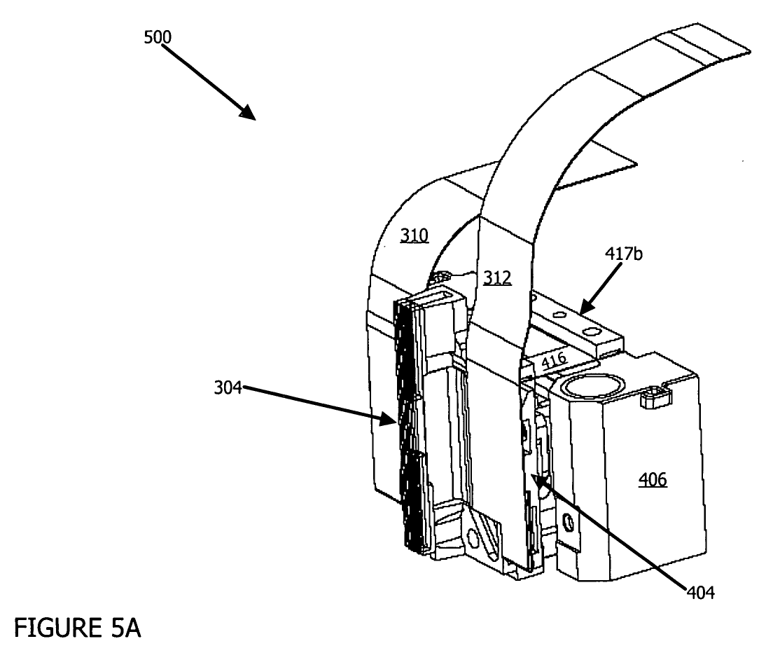

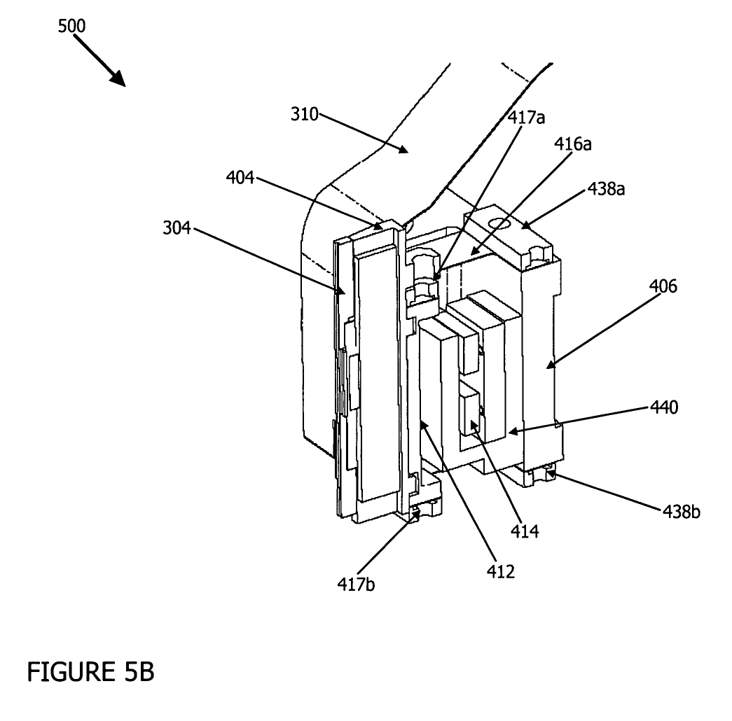

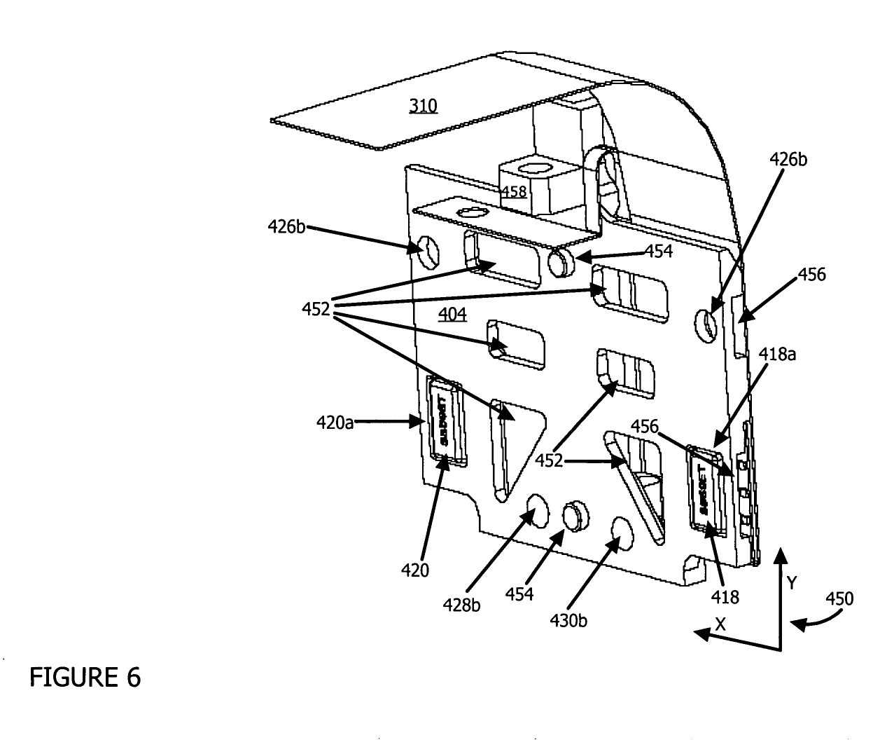

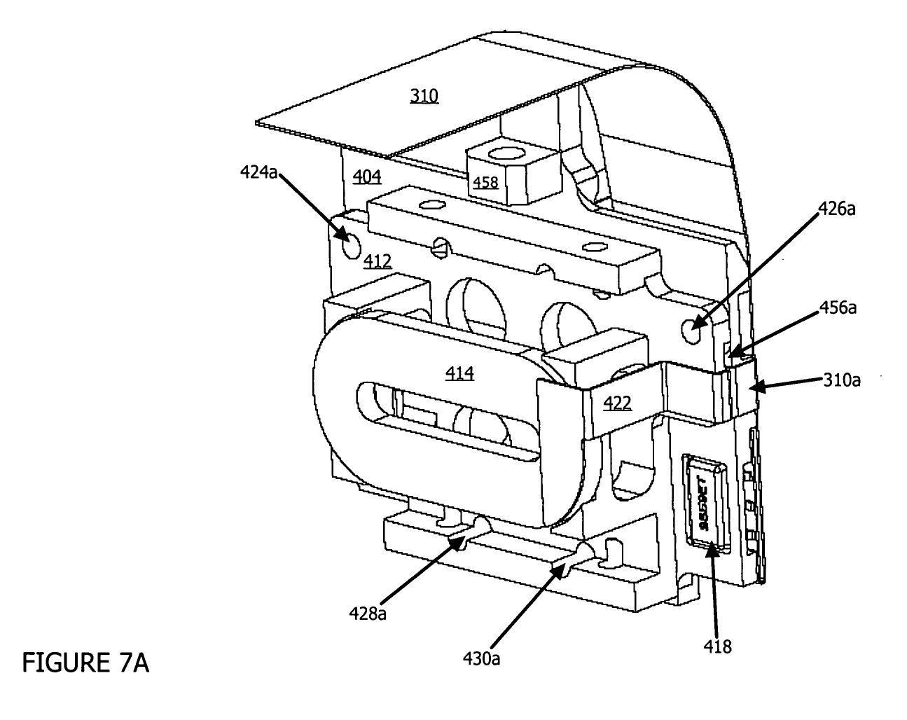

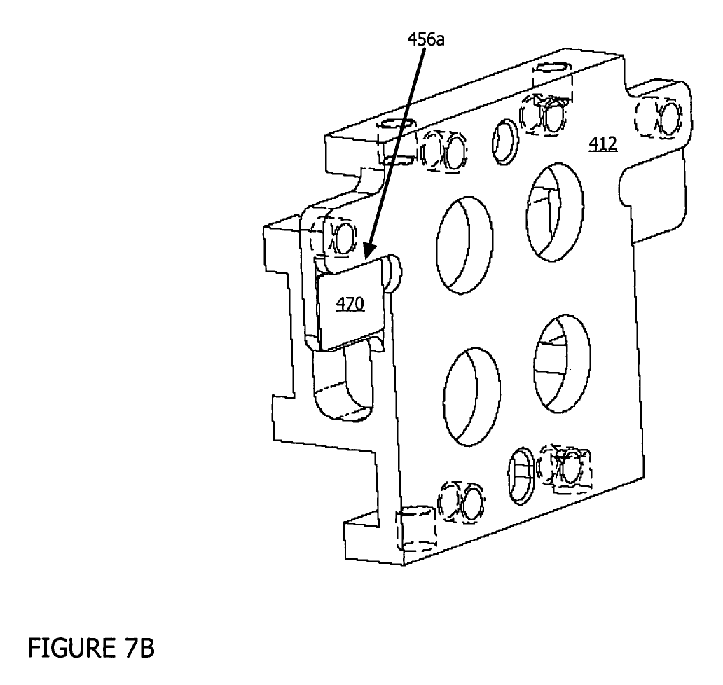

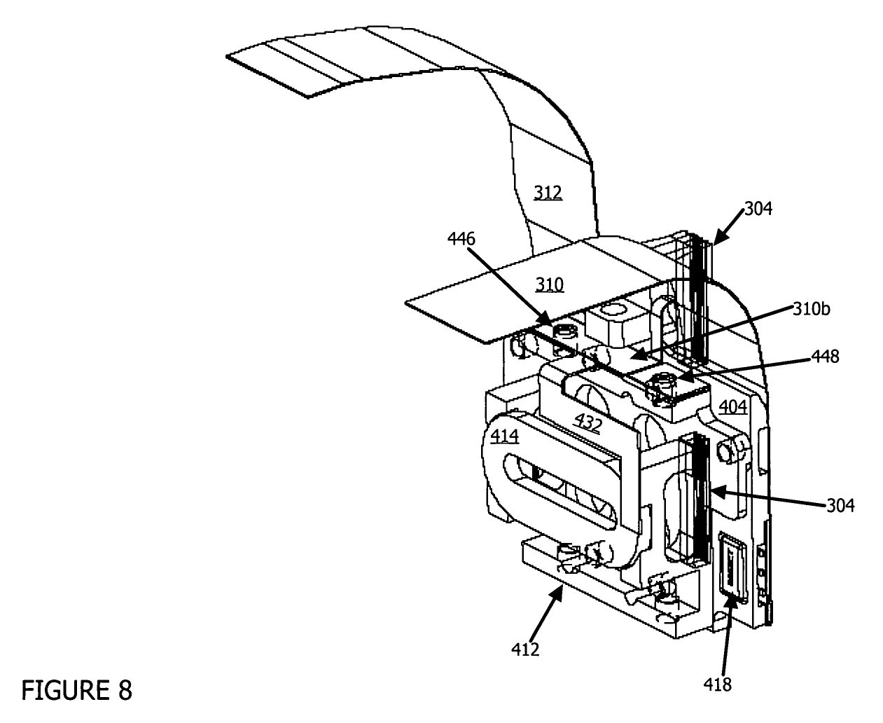

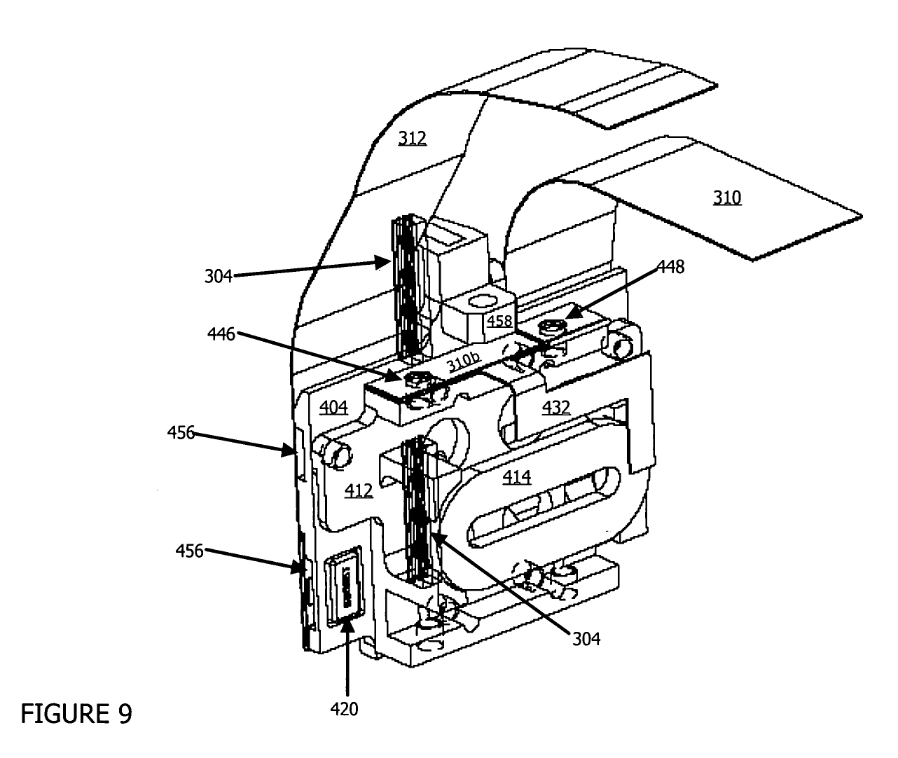

The following sections will now describe the claimed embodiments in detail beginning with FIG. 4, which is a perspective view of an actuator assembly 400, and FIG. 5A, which is a perspective view of a fine actuator 500, in accordance with an exemplary embodiment. Actuator assembly 400 includes a base plate assembly 402 upon which the balance of the actuator assembly components are directly or indirectly coupled to. One of those components is the fine actuator 500 that includes a magnetic head 304, a head carriage 404 to which the magnetic head 304 is coupled to, a reference hall sensor 418 (see FIGS. 6-8) mated with the head carriage 404 and a linear hall sensor 420 (see FIGS. 6 and 9) which is also mated with the head carriage 404. The fine actuator further includes a voice coil motor which includes a voice coil holder 412 coupled to the head carriage 404 and a voice coil 414 coupled to the voice coil holder (refer to FIGS. 7 and 8 to view the voice coil holder 412 and the voice coil 414). Head flex circuits (310, 312) are used in conjunction with the actuator assembly 400 and are attached to the head carriage 404. The head flex circuits (310, 312) provide electrical connections to the magnetic head 304 and one of them (310, 312) or both can further provide electrical connections to the voice coil 414 and positional sensors (418/refer to FIG. 6). Note that the head carriage 404 is for the most part blocked in the view of FIG. 4 by the head flex circuits (310, 312).

A head carriage assembly refers to the combination of the magnetic head 304 and the head carriage 404. Also, some embodiments utilize the phrase “magnetic head assembly” and that refers to the head carriage 404, magnetic head 304, head flex circuits (310, 312) and positional sensors (418, 420).

FIG. 5B depicts a cut-through perspective view of the fine actuator 500 of FIG. 5A. One portion of the fine actuator 500 is its moving mass and that includes the magnetic head 304, the head carriage 404, the voice coil holder 412, the voice coil 414; the head flex circuits (310, 312) and the sensors (418 and 420). This collection of parts is referred to as the moving mass because it moves via the force created by the voice coil 414 under servo-control electronics. The flexures 416a and 416b suspend the entire moving mass of the fine actuator 500. One side of the flexures (416a, 416b) is secured to the moving mass by the clamps 417a and 417b. The clamps (417a, 417b) and the relevant screws (not shown) are also part of the moving mass. The other side of the flexures (416a, 416b) is secured to the coarse base 406, by the clamps 437a and 437b and screws (not shown). The voice coil 414 is inside a magnetic field of the voice coil motor 440 which is attached to the coarse actuator base 406.

The actuator assembly 400 further includes a coarse actuator which is not visible in the various views of the figures. The coarse actuator, which includes a stepper motor with a gear train, translates the fine actuator 500 up or down across the full width of a tape. The coarse base 406 is guided via the precision guide-pins 408. There are biasing springs 410 to eliminate the backlash of the gears. The precision guide-pins 408 are secured to the actuator base plate 402 at the bottom and by the top-cap 413 at the top using screws (not shown).

The following sections summarize the basic operation of the positional sensors (418, 420) which are utilized to place the magnetic head 304 at a correct vertical position in relation to a tape track. In combination with servo signals contained on a tape, the fine actuator 500 is moved responsive to signals transduced by servo read elements, located on the magnetic head 304, which read servo bands on a magnetic tape. The movement of the fine actuator 500, based on the transduced servo signals, keeps the magnetic head 304 in substantial alignment with a selected track on the tape.

The trigger point of the reference hall sensor magnet assembly (located on the base plate assembly 402 but not shown) provides a known location for the magnetic head 304 with respect to tape. The linear hall sensor 420 along with a reference hall sensor magnet assembly 411 (located inside a slot of the coarse base 406 /refer to FIG. 4) that provides the translation information of the fine actuator 500.

Regarding the reference hall sensor 418 and the reference hall sensor magnet assembly, during a read-write process of the tape drive 200, the magnetic head 304 traverses across a tape to seek a relevant track. There are a number of incidents when the magnetic head 304 must be parked at a given known/reference location. Such events may include booting up the tape drive 200, tape-loading sequence, etc. In order to send the magnetic head 304 to this reference location, the reference hall-sensor magnet assembly and reference hall sensor 418 are utilized. The reference hall magnet assembly is secured to the actuator base plate 402 and the reference hall sensor 418 is secured to the head flex circuit 310. The actuator base plate 402 is stationary to the drive 200. Thus, when the reference hall sensor 418 arrives in the vicinity of the reference hall magnet assembly, the reference hall sensor 418 is triggered. This information is utilized to locate the magnetic head 304 with respect to the tape.

In reference to the linear hall sensor 420 and the reference hall sensor magnet assembly 411, the fine actuator 500 is utilized to keep the head on a track under a servo control. Any movements in the tape or head carriage 404 can create a misalignment between the magnetic head 304 and the track on the tape. It should be noted that the linear hall sensor 420 is utilized for motion of the fine actuator 500, only. The linear hall sensor 420 is attached to the head flex circuit 312. The corresponding dual pole magnet is attached to the coarse actuator base 406. The linear hall sensor 420 will move with respect to the dual pole magnet. The dual pole magnet has two poles—north and south. When the linear hall sensor 420 is aligned to a null line of the dual pole magnet, there is no signal. When the magnetic head 304 moves up, the linear hall sensor 420 produces the signal which is proportional to the head-translation. The same is true when the magnetic head 304 moves in the negative direction. As a result, the linear hall sensor 420 provides the signal which is proportional to the head translation. This information can be used in number of ways. Some examples include 1) damping of the servo loop and 2) when tape is at the end and it reverses the direction to move from forward to reverse, there is no servo information from the tape. The linear hall sensor 420 provides the head location information during this phase.

As previously mentioned, accurate placement of the positional sensors (reference hall sensor 418 and linear hall sensor 420) in relation to the magnetic head 304 and associated reference magnets is critical. Due to deficiencies in the prior art, misplacement of the positional sensors typically result in a significant actuator rejection rate during assembly. The claimed embodiments advantageously improve upon this situation. How this is achieved can be seen via FIG. 6 which is a perspective view of a backside of the head carriage 404 which illustrates an embodiment for precisely locating positional sensors (418, 420), in accordance with an exemplary embodiment. The positional sensors (418, 420) are attached at respective ends of the head flex circuits (310, 312) and fold over the top cap 413 (refer to FIG. 4). The head flex circuits (310, 312) each also have bottom ends (421, 423). As shown in FIG. 4, the bottom ends (421, 423) are limited in width. This limited width facilitates installation of the sensors (418, 420) in accordance head flex circuit design guidelines.

The linear hall sensor 420 is electrically coupled to head flex circuit 312 (not shown) and the reference hall sensor 418 is electrically coupled to head flex circuit 310. Head carriage 404 includes sensor location features 418a and 420a into which the positional sensors (418, 420) can be securely and accurately placed. Placement of the sensor location features (418a, 420a) on the head carriage 404 can be very accurately controlled due to advanced manufacturing processes used to produce the head carriage 404. Some examples of advanced manufacturing processes used to fabricate the head carriage 404 include machining and die casting which is primarily used for aluminum parts. Therefore, the sensor location features (418a, 420a) determine the location of the positional sensors (418, 420) even though those positional sensors (418, 420) are electrically coupled/mounted on the head flex circuits (310, 312). As a result, the tolerances for the mounting locations of the positional sensors (418, 420) relative to the head flex circuits (310, 312) can be relatively large. Any misplacement of the positional sensors (418, 420) on the head flex circuits (310, 312) is corrected when the positional sensors (418, 420) are placed within their corresponding sensor location features (418a, 420a).

In one implementation, the sensor location features (418a, 420a) are cut-through sections on the head carriage 404. In another implementation, the sensor location features (418a, 420a) are indentations in the head carriage 404.

In yet another implementation, only one dimension of the sensor location features (418a, 420a) substantially corresponds to a corresponding dimension of the sensors (418, 420). For example, if a shape of the sensor (418 or 420) is generally rectangular or square, either the length or width could substantially correspond to a corresponding dimension of the sensor location features (418a, 420a). This particular implementation could be employed in a situation where a sensor (418 or 420) is required to be accurately located in a horizontal plane or a vertical plane but not both. For example, a sensor (418 or 420) could perhaps only need to be located anywhere on head carriage 404 at a specific y-axis horizontal point as defined by the axes 450 in FIG. 6. As a result, only a specific vertical dimension of the sensor location feature (418a, 420a) would need to defined, in head carriage 404, with a midline at the required y-axis point. The horizontal dimension of the sensor location feature (418a or 420a) would only need to be large enough to accommodate the corresponding horizontal dimension of the sensor (418 or 420) but could be larger as the vertical x-axis location is not critical. In a similar manner, a sensor (418 or 420) could perhaps have an installation requirement to be located at a specific x-axis vertical location but have no required y-axis horizontal location requirement. As a result, a horizontal dimension of the sensor location feature (418a or 420a) would need to be defined on head carriage 404 with a midline at the specific x-axis vertical point. The vertical dimension of the sensor location feature (418a or 420a) would need to be wide enough to accommodate a corresponding vertical dimension of the sensor (418 or 420) but can be larger thus allowing a larger vertical x-axis installation window.

It should also be noted that the sensor location features (418a, 420a) are an integral or integrally formed aspect of the head carriage 404.

Typically, the positional sensors (418, 420) are mated with the sensor location features (418a, 420a) utilizing a light press fit or a light clearance fit to ensure that the positional sensors (418, 420) remain fitted to location sensor features (418a, 420a). In one implementation, an adhesive is utilized to attach one side of the positional sensors (418, 420) to the head flex circuits (310, 312) and the other side of the positional sensors (418, 420) to the head carriage 404. In another implementation, pressure sensitive tape is utilized which has an adhesive on both sides of the tape. Determining an appropriate size for the sensor location features (418a, 420a) is determined in relation to the size of the positional sensors (418, 420). Determining an optimal size for the sensor location features (418a, 420a) in order to ensure a proper fit for the positional sensors (418, 420) is well within the skill set of the average artisan and will therefore not be described so as to not unnecessarily obscure the claimed embodiments.

Head carriage 404 further includes various design-dependent features that are generally independent of the claimed embodiments. Restated, their inclusion and placement may, in some implementations, effect the claimed embodiments while in other implementations have no effect at all. Some of these design-dependent features include weight-reducing cutouts 452 and locating knobs 454 which can mate with a corresponding depression (not depicted in the figures) in the voice coil holder 412. The locating knobs 454 facilitate installation of a new head carriage assembly. For example, if during the final test, it was discovered that the head carriage assembly is defective, it will be necessary to replace it. In this situation, a new head-carriage assembly would be positioned in substantially the same position as the defective head carriage assembly due to the locating knobs 454

Head carriage 404 also includes various compartments 456 which are also repeated on the other side of the head carriage/refer to FIG. 9. Typically, only one of the compartments 456 will be utilized even though both will be on the head carriage 404. A compartment 456a (refer to FIGS. 7A-7B) is utilized to clamp portion of flex circuits together and this will be further described in a subsequent section. The head carriage 404 also has a tab 458 used to secure the head carriage assembly to the voice coil holder 412 via an additional screw (not shown) that goes between the head carriage 404 and the top flexure clamp 417a.

The claimed embodiments also provide for a reduced number of separate connections to the tape drive PCB from various drive components. For example, the positional sensors (418, 420) are mounted on the head flex circuits (310, 312). As a result, separate PCB connectors are not required for the positional sensors (418, 420). In a similar manner, head flex circuit 310 can also be utilized to provide a connection between the voice coil motor and the PCB. More specifically, though, the claimed embodiments provide for the connection between the voice coil 414 and the head flex circuit 310 without the use of soldering and is described via FIGS. 7A-7B.

FIG. 7A is a perspective view of the voice coil 414, a voice coil holder 412 and the head carriage 404. FIG. 7B. is a perspective view of the voice coil holder 421. Additionally, FIGS. 7A and 7B illustrate an embodiment for clamping a voice coil flex circuit 422 to a portion of the head flex circuit 310a, in accordance with an exemplary embodiment. Referring to FIG. 7B, a thin rectangular part 470, made from a compliant material, is located in the compartment 456a and the thin rectangular part 470 is attached to a wall of the compartment 456a using pressure sensitive tape. An example of a compliant material to use for the thin rectangular part 470 is Buna-N rubber, or a similar material, with a thickness of about 0.50 mm, in one implementation, and a shore hardness of about 30 shore-A, in one implementation. The purpose of the thin rectangular part 470 is to ensure that there will be a clamping force between the relevant pads of the voice coil flex circuit 422 and the head flex circuit portion 310a. Due to mechanical tolerance conditions of the voice coil flex circuit 422 and the head flex circuit portion 310a, sufficient clamping force may not be ensured without the presence of the thin rectangular part 470. It should be noted that while the thin rectangular part 470 is rectangular, the claimed embodiments are not meant to be limited in such a fashion as various other shapes can be utilized. The thin rectangular part 470 is rectangular since the compartment 456a is also rectangular. It should also be noted that FIG. 7B intentionally does not include the voice coil flex circuit 422 in order to be able to show the thin rectangular part 470.

The voice coil 414 includes two wires (not shown) which are soldered to the voice coil flex circuit 422 at their respective ends. The voice coil flex circuit 422 is attached to the voice coil 414 using an adhesive between the voice coil 414 and the voice coil flex circuit 422. The voice coil flex circuit 422 is designed to have two lines that form an electrical continuity between the voice coil wires and the two pads at its other end where the voice coil flex circuit 422 is clamped to the head flex circuit portion 310a. The end of the voice coil flex circuit that is clamped to the head flex circuit portion 310a has two exposed pads—a positive pad and a negative pad. The voice coil flex circuit 422 is routed from the voice coil 414, as shown in FIG. 7A, and terminates at the compartment 456. The end of the voice coil flex circuit 422, where the two pads rests on the thin rectangular part 456, is secured to the thin rectangular part 456 using pressure sensitive tape. The exposed pads are facing out meaning they can be seen when the head carriage 404 is not assembled. In a similar fashion, head flex circuit portion 310a wraps around to the backside of head carriage 404 and has two corresponding positive and negative pads. Electrical connectivity between the pads is accomplished when the voice coil motor 412 is securely clamped with the head carriage 404. The positive and the negative pads are substantially mated because both of the flex circuits (310a, 422) along with the thin rectangular part 470 are placed in the compartment 456. The force necessary to mate these pads comes by a screw, which is placed on the head carriage 404 and is threaded into the threaded-hole 426a of the voice coil holder 412. This particular screw is also used to attach the head carriage assembly to the voice coil holder 412. Furthermore, there are additional screws used to attach the head carriage to the voice coil holder are fastened at the threaded holes 424a, 428a and 430a.

Since the embodiment of FIGS. 7A-7B does not utilize soldering to connect the voice coil flex circuit 422 to head flex circuit portion 310a, the various disadvantages associated with soldering that were described in the background section are eliminated for this particular connection. Additionally, the embodiment of FIGS. 7A-7B further allows for the head carriage 404 to be directly removed from the actuator assembly 400 as there are only screws holding the head carriage 404 to the voice coil holder 412 and no soldered connections to undo. This aspect is particularly advantageous as the head carriage can be easily/directly removed from the actuator assembly in case the magnetic head needs to be repaired or replaced.

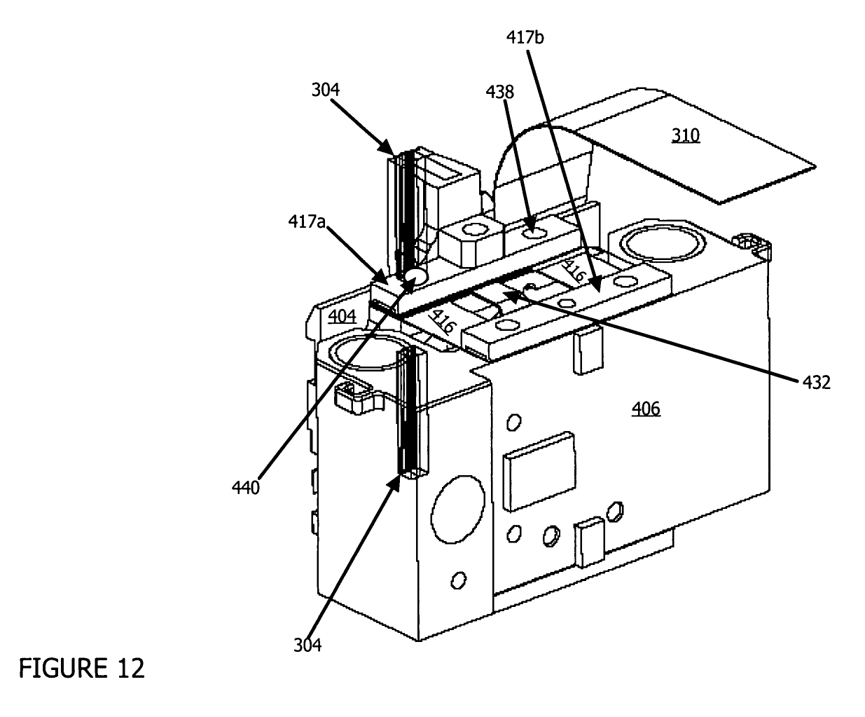

The claimed embodiments also envision an alternate clamping embodiment to connect a voice coil flex circuit to a head flex circuit and this embodiment is depicted via FIGS. 8-12. Instead of clamping a voice coil flex circuit with a head flex circuit between the head carriage 404 and the voice coil holder 412, the embodiment of FIGS. 8-12 instead clamps a voice coil flex circuit 432 and a portion of the head flex circuit 310b between the voice coil holder 412 and the top flexure clamp 417a. In another implementation, a portion of head flex circuit 312 is utilized to be clamped with voice coil holder 412. It should be noted that only FIG. 12 shows top flexure clamp 417a.

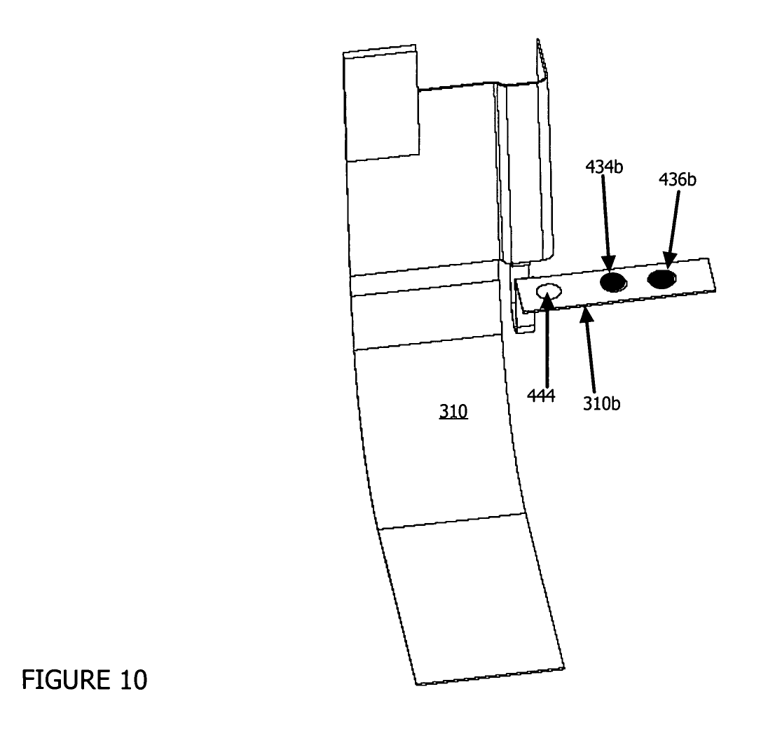

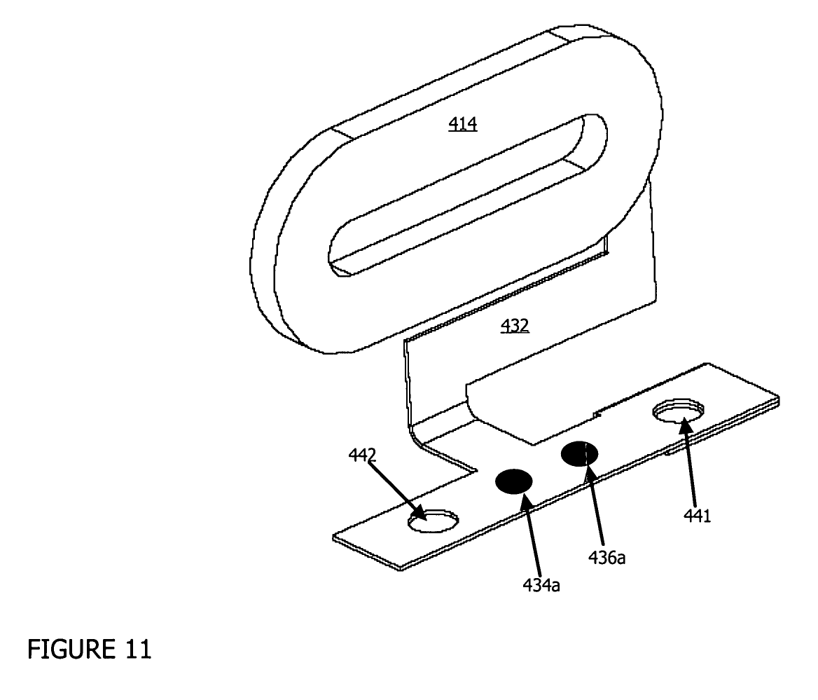

Similar to the previous embodiment, voice coil flex circuit 432 has positive and negative pads (434a, 436a/see FIG. 11) that match up with corresponding positive and negative pads (434b, 436b/see FIG. 10). The clamping and resultant electrical connection is accomplished by inserting screws into the top flexure clamp at holes 438 and 440 (FIG. 12) which in turn go through holes 441 and 442 (FIG. 11) of voice coil flex circuit 432, hole 444 (FIG. 10) of head flex circuit portion 310b and holes 446 and 448 (FIG. 9) of the voice coil holder 412.

This embodiment also eliminates the need to solder the voice coil flex circuit 432 to the head flex circuit portion 310b. However, in order to remove the head carriage 404 from the actuator assembly 400, the top flexure clamp 417a will need to be removed as well as the screws holding the voice coil holder 412 to the head carriage 404.

Advantageously, the claimed embodiments provide for numerous advantages over the prior art. These advantages include precise placement of positional sensors, integration of connections without soldering and improved removal processes for detaching a magnetic head assembly from an actuator assembly.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A head carriage for use in a tape drive comprising:
a head carriage body;
a magnetic head attachment feature disposed to receive a magnetic head; and
one or more sensor location features integrally formed in the head carriage body.

2. The head carriage as recited in claim 1 wherein the one or more sensor location features are at least one cut-through section on the head carriage body.

3. The head carriage as recited in claim 1 wherein the one or more sensor location features are at least one indentation on the head carriage body.

4. The head carriage as recited in claim 2 wherein the one or more sensor location features are generally square-shaped or generally rectangular-shaped and wherein both length and height dimensions of the one or more sensor location features generally match corresponding sensor height and length dimensions.

5. The head carriage as recited in claim 4 wherein the length dimension of the one or more sensor location features generally corresponds to the sensor length dimension and wherein the height dimension of the one or more sensor location features is greater than the sensor height dimension.

6. The head carriage as recited in claim 4 wherein the height dimension of the one or more sensor location features generally corresponds to the sensor height dimension and wherein the length dimension of the one or more sensor location features is greater than the sensor length dimension.

7. The head carriage as recited in claim 1 wherein the one or more sensor location features are two sensor location features for use with a reference hall sensor and a linear hall sensor.

8. The head carriage as recited in claim 1 further comprising a voice coil motor coupled to the head carriage body.

9. The head carriage as recited in claim 6 wherein the voice coil motor comprises a voice coil holder coupled to the head carriage body and a voice coil coupled to the voice coil holder.

10. A head carriage for use in a tape drive comprising:
a head carriage body;
a magnetic head coupled to the head carriage body;
a head flex circuit electrically coupled to the magnetic head;
a voice coil motor coupled to the head carriage;
a voice coil flex circuit electrically coupled to the voice coil motor;
wherein a portion of the voice coil flex circuit is clamped to a portion of the head flex circuit whereby the clamping ensures an electrical connection between the two portions.

11. The head carriage as recited in claim 10 wherein the voice coil motor comprises a voice coil holder coupled to the head carriage body and a voice coil coupled to the voice coil holder and wherein the voice coil flex circuit is electrically coupled to the voice coil.

12. The head carriage as recited in claim 11 wherein the portions overlap each other on a section of the voice coil holder that is not in direct contact with the head carriage.

13. The head carriage assembly as recited in claim 12 wherein a top flexure clamp screwed on top of the portions to the voice coil motor provides for the clamping.

14. The head carriage assembly as recited in claim 14 wherein the portions overlap each other between the voice coil holder and the head carriage.

15. The head carriage assembly as recited in claim 14 further comprising a compliant material located on one of the sides of the portions wherein the compliant material aids in establishing the electrical connection.

16. The head carriage assembly as recited in claim 14 wherein screws coupling the voice coil holder to the head carriage provides for the clamping.

17. The head carriage assembly as recited in claim 10 further comprising one or more sensor location features integrally formed in the head carriage body.

18. In a tape drive containing an actuator assembly that includes a magnetic head assembly, the improvement comprising:
the magnetic head assembly configured to be directly detachable from the actuator assembly.

19. The tape drive as recited in claim 18 wherein the magnetic head assembly includes a head carriage, a magnetic head coupled to the head assembly, first and second head flex circuits electrically coupled to the magnetic head, a reference hall sensor electrically coupled to the first head flex circuit, a linear hall sensor electrically coupled to the second head flex circuit wherein the improvement further comprises:
a first cut-out section in the head assembly that mates with the reference hall sensor and a second cut-out section in the head assembly that mates with the linear hall sensor whereby the first and second cut-out sections define preferred locations for the reference and linear hall sensors.

20. The tape drive as recited in claim 19 wherein the actuator assembly further includes a voice coil holder, a voice coil coupled to the voice coil holder and a voice coil flex circuit electrically coupled to the voice coil wherein the improvement further comprises:
a portion of the voice coil flex circuit clamped to a portion of the first head flex circuits, when the magnetic head assembly is coupled with the actuator assembly, whereby the clamping ensures an electrical connection between the two portions wherein the portions overlap each other between the voice coil holder and the head carriage.
